(19) United States
(12) Patent Application Publication
(10) Pub. No.: US 2022/0127787 A1
(43) Pub. Date: Apr. 28, 2022

(54) INKJET PRINTING

(71) Applicant: Hewlett-Packard Development Company, L.P., Spring, TX (US)

(72) Inventors: Zhang-Lin ZHOU, San Diego, CA (US); Ronal Albert ASKELAND, San Diego, CA (US); Or BRANDSTEIN, San Diego, CA (US); AIi MAHROU, San Diego, CA (US)

(73) Assignee: Hewlett-Packard Development Company, L.P., Spring, CA (US)

(21) Appl. No.: 17/433,187

(22) PCT Filed: Nov. 19, 2019
(86) PCT No.: PCT/US2019/062092

§ 371 Date: Aug. 23, 2021

(51) Int. Cl. D06P 5/30; C09D 11/102; C09D 11/322; C09D 11/033; C09D 11/037; C09D 11/40; D06P 1/52; B41M 5/00; B41M 7/00

(52) U.S. Cl. CPC D06P 5/30; C09D 11/102; C09D 11/322; C09D 11/033; C09D 11/037; C09D 11/40; D06P 3/60; D06P 1/5207; B41M 5/0023; B41M 7/0081; B41M 5/0047; B41M 5/0064; D06P 1/5285

(57) ABSTRACT

The present disclosure describes methods of printing, textile printing systems, and printers. In one example, a method of printing can include jetting an ink composition onto a substrate, the ink composition including an evaporable solvent, a colorant, and a non-curable polymeric binder. The ink composition on the substrate can be exposed to electromagnetic radiation having a wavelength from 350 nm to 420 nm. The exposure of the ink composition can begin from 0 ms to 600 ms after jetting the ink composition. The electromagnetic radiation can heat the ink composition to evaporate a portion of the evaporable solvent from the ink composition within 5 ms to 500 ms after the beginning of the exposure.

### BACKGROUND

Inkjet printing has become a popular way of recording images on various media. Some of the reasons include low printer noise, variable content recording, capability of high-speed recording, and multi-color recording. These features can be obtained at a relatively low price to consumers. As the popularity of inkjet printing increases, the types of use also increase providing demand for new ink compositions. In one example, textile printing can have various applications including the creation of signs, banners, artwork, apparel, wall coverings, window coverings, upholstery, pillows, blankets, flags, tote bags, clothing, etc. However, bleed control, color intensity, and permanence of printed ink on textiles can be difficult to achieve.

### BRIEF DESCRIPTION OF DRAWINGS

FIG. 1 is a flow diagram for an example method of printing in accordance with the present disclosure;

FIG. 2 schematically depicts an example textile printing system in accordance with the present disclosure;

FIG. 3 schematically depicts an example printer in accordance with the present disclosure; and

FIG. 4 schematically depicts another example printer in accordance with the present disclosure.

### DETAILED DESCRIPTION

The present disclosure is drawn to methods of printing, textile printing systems, and printers that can provide good optical density and control bleed of the printed ink. In one example, a method of printing includes jetting an ink composition onto a substrate, where the ink composition includes an evaporable solvent, a colorant, and a non-curable polymeric binder. The ink composition on the substrate is exposed to electromagnetic radiation having a wavelength from 350 nm to 420 nm. The exposure of the ink composition begins from about 0 ms to about 600 ms after jetting the ink composition. The electromagnetic radiation heats the ink composition to evaporate a portion of the evaporable solvent from the ink composition within 5 ms to 500 ms after the beginning of the exposure. In certain examples, the electromagnetic radiation can be produced by a light emitting diode having a center emission wavelength of about 365 nm, about 385 nm, about 395 nm, or about 405 nm. In further examples, the total energy applied by the electromagnetic radiation can be from 0.3 J/cm² to 3 J/cm². In some examples, the colorant can be a pigment that absorbs the electromagnetic radiation to generate heat. In other examples, the non-curable polymeric binder can include a polyurethane, a latex polymer, a hybrid latex-polyurethane co-polymer, or a combination thereof. In still further examples, the substrate can be a fabric substrate that includes cotton, polyester, silk, nylon, or a blend thereof. In certain examples, no fixer composition may be applied to the substrate before or after the ink composition.

The present disclosure also describes textile printing systems. In one example, a textile printing system includes a fabric substrate, an inkjet printhead to jet an ink composition onto the fabric substrate, an ink reservoir that includes the ink composition, and an electromagnetic radiation source. The ink reservoir is connected in fluid communication with the inkjet printhead or connectable in fluid communication with the inkjet printhead. The ink composition includes an evaporable solvent, a colorant, and a non-curable polymeric binder. The electromagnetic radiation source has a center emission wavelength from 350 nm to 420 nm to expose the ink composition jetted onto the fabric substrate to electromagnetic radiation from 0 ms to 600 ms after the ink composition is jetted onto the fabric substrate to evaporate a portion of the evaporable solvent from the ink composition within 5 ms to 500 ms after the beginning of the exposure. In some examples, the electromagnetic radiation source can be positioned within 15 cm from a nozzle of the inkjet printhead through which the ink composition is jetted. In further examples, the electromagnetic radiation source can include a light emitting diode having a center emission wavelength of about 365 nm, about 385 nm, about 395 nm, or about 405 nm. In certain examples, the fabric substrate includes cotton, polyester, silk, nylon, or a blend thereof.

The present disclosure also describes printers. In one example, an inkjet printer includes an inkjet printhead, an ink reservoir connected in fluid communication with the inkjet printhead, an electromagnetic radiation source, and a hardware controller. The ink reservoir includes an ink composition that includes an evaporable solvent, a colorant, and a non-curable polymeric binder. The electromagnetic radiation source has a center emission wavelength from 350 nm to 420 nm. The hardware controller is to generate a command to direct the inkjet printhead to jet the ink composition onto a substrate and direct the electromagnetic radiation source to expose the ink composition on the substrate to electromagnetic radiation. The exposure of the ink composition begins from 0 ms to 600 ms after jetting the ink composition, and the electromagnetic radiation heats the ink composition to evaporate a portion of the evaporable solvent from the ink composition within 5 ms to 500 ms after the beginning of the exposure. In some examples, the printer can also include a carriage and the radiation source and the inkjet printhead can be positioned on the carriage. In further examples, the electromagnetic radiation source can include a light emitting diode having a center emission wavelength of about 365 nm, about 385 nm, about 395 nm, or about 405 nm. In certain examples, the fabric substrate can include cotton, polyester, silk, nylon, or a blend thereof.

When referring to the wavelength of electromagnetic energy emitted from the electromagnetic radiation source, the center emission wavelength of energy is found in the ultraviolet (UV) or near-ultraviolet (near UV), namely from 350 nm to 420 nm, as mentioned. For example, from a UV LED source, the wavelength range can be a relatively narrow band of energy, such as a narrow band of about 10 nm to 50 nm, with the center wavelength emission of the energy range positioned centrally within the range, which often corresponds with the peak energy wavelength also within the range. In examples herein, the center wavelength emission may be about 365 nm, about 385 nm, about 395 nm, or about 405 nm, which correspond with commercially available UV LED light sources with narrow band emission.

It is noted that when discussing the ink compositions, textile printing systems, printers, or the methods of printing herein, these discussions can be considered applicable to one another whether or not they are explicitly discussed in the context of that example. Thus, for example, when discussing an organic co-solvent related to the ink composition, such disclosure is also relevant to and directly supported in the context of the methods of printing, and vice versa. It is also understood that terms used herein will take on their ordinary meaning in the relevant technical field unless specified otherwise. In some instances, there are terms defined more specifically throughout the specification or included at the end of the present specification, and thus, these terms have a meaning as described herein.

### Methods of Printing

As mentioned above, the methods of printing described herein can involve jetting an ink composition onto a substrate and then pinning the ink composition by quickly heating the ink composition using light in the ultraviolet (UV) or near-UV range. Heating the ink composition can cause a portion of the solvent in the ink to evaporate, which can increase the viscosity of the ink. If the ink composition is heated quickly enough, then the viscosity can be increased sufficiently to prevent the ink from being absorbed into the substrate or spreading on the surface of the substrate.

When ink is printed onto a substrate, especially porous substrates such as textiles, the ink can tend to penetrate beneath the surface of the substrate. The portion of the colorant in the ink that penetrates into the substrate may not be as visible as colorant that remains on the surface of the substrate. Therefore, when the substrate absorbs the ink in this way, the optical density of the printed ink is diminished. Additionally, ink can spread across the surface of a substrate after printing. This can cause bleed when one color of ink spreads into an area where another color of ink is printed.

In some cases, ink penetration and bleed can be controlled by applying a pretreatment or fixer composition to the substrate before or after printing the ink. For example, a fixer composition can include ingredients that chemically react with ingredients in the ink to fix the colorant of the ink in place on the surface of the substrate. However, using such a fixer composition increases the cost of printing by increasing the raw materials used during printing and also adding the hardware for applying the fixer composition.

The methods described herein can reduce both absorption of the ink composition into the substrate and bleed of the ink composition across the surface of the substrate. The ink composition can be heated quickly to evaporate a sufficient amount of the solvent so that the ink does not penetrate into the substrate or spread across the surface of the substrate. Because ink penetration and bleed are processes that occur relatively quickly, the methods described herein can involve heating the ink composition quite quickly, such as within about 600 ms after printing the ink composition onto the substrate. Furthermore, the methods described herein can control optical density and bleed without using a separate fixer composition.

In some examples, the ink composition printed on the substrate can be heated by exposing ink composition to light (or electromagnetic radiation) in the UV or near-UV range. The wavelength of the electromagnetic radiation can be from 350 nm to 420 nm. This electromagnetic radiation can be absorbed by colorants in the ink composition, such as pigments. The absorbed radiation energy can be converted into thermal energy, causing the temperature of the ink composition to increase. UV light has previously been used in some cases to cure ink that has been printed onto a substrate. For example, curable ink compositions may include photoinitiators that can initiate a polymerization or cross-linking reaction in the curable ink when exposed to UV light. UV light may also have been used to dry ink after printing, in some cases. Thus, UV light sources may have been included in previous printing methods. However, the UV light used for curing or drying typically has been applied later, after printing. Therefore, such application of UV light would not have been effective for pinning the ink composition quickly after printing. In contrast with the use of UV light for curing a curable ink composition, the methods described herein can include non-curable ink compositions. The electromagnetic radiation used in the methods described herein can pin non-curable ink compositions to control optical density and bleed without curing. Therefore, a wide variety of non-curable binders can be successfully used in the ink compositions described herein.

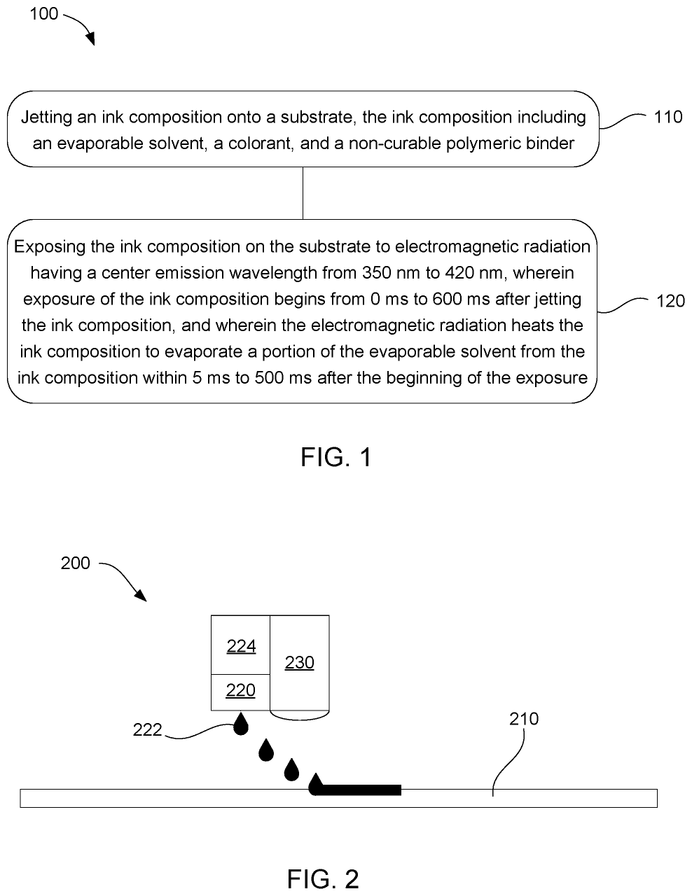

With this description in mind, FIG. 1 shows a flowchart of an example method 100 of printing. The method includes: jetting 110 an ink composition onto a substrate, the ink composition including an evaporable solvent, a colorant, and a non-curable polymeric binder; and exposing 120 the ink composition on the substrate to electromagnetic radiation having a wavelength from 350 nm to 420 nm, wherein exposure of the ink composition begins from 0 ms to 600 ms after jetting the ink composition, and wherein the electromagnetic radiation heats the ink composition to evaporate a portion of the evaporable solvent from the ink composition within 5 ms to 500 ms after the beginning of the exposure.

The methods of printing described herein can be used with a wide variety of ink compositions. Details about ingredients that can be included in the ink compositions are described more fully below. In many examples, the ink composition can include an evaporable solvent, such as water, an organic solvent, or a combination of water and an organic co-solvent. In some examples, the evaporable solvent can evaporate at a temperature from 50° C. to 200° C. The evaporable solvent can evaporate sufficiently quickly when heated by the electromagnetic radiation that a portion of the evaporable solvent evaporates within 5 ms to 500 ms after the ink composition is exposed to the electromagnetic radiation.

In various examples, the amount of the evaporable solvent that is evaporated by the electromagnetic radiation can be any amount that is sufficient to increase the viscosity of the ink composition. In some examples, a sufficient amount of evaporable solvent can evaporate so that the ink composition is viscous enough to remain fixed on the surface of the substrate. In other words, the ink composition can be sufficient viscous that no visible change can be seen in the printed ink composition thereafter due to the ink being absorbed by the substrate or due to the ink bleeding into other areas of the substrate. In certain examples, the amount of the evaporable solvent that is evaporated by the electromagnetic radiation can be from 20 wt % to 100 wt %, or from 40 wt % to 99 wt %, or from 60 wt % to 95 wt %, with respect to the total weight of evaporable solvent in the ink composition before printing. In further examples, the ink composition can have a solids content after the electromagnetic radiation has been applied from 30 wt % to 100 wt %, or from 50 wt % to 99 wt %, or from 70 wt % to 99 wt %.

The ink composition can also include a colorant. Specific examples of colorants are described in more detail below. The colorant can include a variety of colorants that are capable of absorbing the electromagnetic radiation applied to the ink composition in order to generate heat. In some examples, the colorant can be a pigment. The ink can often be a colored ink or a black ink used for printing images or text. Therefore, in some examples the colorant can be a black pigment or a colored pigment. Specific colors that can often be used include cyan, magenta, yellow, red, blue, green, and others. These pigments can absorb electromagnetic radiation having a variety of wavelengths. The particular visible color of a pigment can be caused by the ability of the pigment to absorb certain visible wavelengths of light. However, many of these pigments can also absorb a significant amount of light in the wavelength range of 350 nm to 420 nm. In some examples, the pigment can have a peak absorption wavelength within the wavelength range of 350 nm to 420 nm, while in other examples the peak absorption wavelength can be in the visible range or in another range. Regardless of the amount of other wavelengths absorbed by the pigment, in some examples the pigment can absorb a sufficient amount of electromagnetic radiation in the 350 nm to 420 nm range to generate heat when the electromagnetic radiation is applied.

The polymeric binder in the ink composition can include any type of non-curable polymeric binder. In some examples, the polymeric binder can contribute to the viscosity of the ink composition when a portion of the evaporable solvent is evaporated. The polymeric binder can include polymers that dissolved in the evaporable solvent or dispersed in the evaporable solvent. In certain examples, the polymeric binder can include a polyurethane, a latex polymer, a hybrid latex-polyurethane co-polymer, or a combination thereof. In further examples, the polymeric binder can be devoid of photoinitiators. As used herein, “photoinitiator” refers to any molecule that can initiate a polymerization, cross-linking, or other type of curing reaction when exposed to light. In particular, the polymeric binder can be devoid of UV photoinitiators, which are compounds that initiate a curing reaction when exposed to UV light.

The ink compositions can be printed on the substrate by jetting. As used herein, “jetting” refers to applying the ink compositions by expelling from ejection or jetting architecture, such as ink-jet architecture. Ink-jet architecture can include thermal or piezo architecture. Additionally, such architecture can be configured to print varying drop sizes such as from about 3 picoliters to less than about 10 picoliters, or to less than about 20 picoliters, or to less than about 30 picoliters, or to less than about 50 picoliters, etc. Accordingly, the ink compositions can be formulated to be jettable using ink-jet architecture.

The methods described herein can be used to print on any type of printing substrate. The increased optical density and bleed control provided by the methods can be especially useful for porous and absorbent substrates. In some examples, the substrate can include paper and similar media. However, in other examples the methods can be used with textile substrates. These can include treated or untreated natural fabric textile substrates, e.g., wool, cotton, silk, linen, jute, flax, hemp, rayon fibers, thermoplastic aliphatic polymeric fibers derived from renewable resources, e.g. cornstarch, tapioca products, sugarcanes, etc. Treated fabrics can include a coating, for example, such as a coating including a cationic component such as calcium salt, magnesium salt, cationic polymer, etc.

In further detail regarding the fabric substrates, fabric substrates can include substrates that have fibers that may be natural and/or synthetic. The fabric substrate can include, for example, a textile, a cloth, a fabric material, fabric clothing, or other fabric product suitable for applying ink, and the fabric substrate can have any of a number of fabric structures. The term “fabric structure” is intended to include structures that can have warp and weft, and/or can be woven, non-woven, knitted, tufted, crocheted, knotted, and pressured, for example. The terms “warp” and “weft” have their ordinary meaning in the textile arts, as used herein, e.g., warp refers to lengthwise or longitudinal yarns on a loom, while weft refers to crosswise or transverse yarns on a loom.

It is notable that the term “fabric substrate” does not include materials referred to as any kind of paper (even though paper can include multiple types of natural and synthetic fibers or mixtures of both types of fibers). Fabric substrates can include textiles in filament form, textiles in the form of fabric material, or textiles in the form of fabric that has been crafted into a finished article, e.g. clothing, blankets, tablecloths, napkins, towels, bedding material, curtains, carpet, handbags, shoes, banners, signs, flags, etc. In some examples, the fabric substrate can have a woven, knitted, non-woven, or tufted fabric structure. In one example, the fabric substrate can be a woven fabric where warp yarns and weft yarns can be mutually positioned at an angle of about 90°. This woven fabric can include but is not limited to, fabric with a plain weave structure, fabric with a twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process, e.g., a solvent treatment, a mechanical treatment process, e.g., embossing, a thermal treatment process, or a combination of two or more of these processes.

Regardless of the structure, in one example, the fabric substrate can include natural fibers, synthetic fibers, or a combination thereof. Examples of natural fibers can include, but are not limited to, wool, cotton, silk, linen, jute, flax, hemp, rayon fibers, thermoplastic aliphatic polymeric fibers derived from renewable resources, e.g. cornstarch, tapioca products, sugarcanes, or a combination thereof. In another example, the fabric substrate can include synthetic fibers. Examples of synthetic fibers can include polymeric fibers such as, polyvinyl chloride (PVC) fibers, PVC-free fibers made of polyester, polyamide, polyimide, polyacrylic, polypropylene, polyethylene, polyurethane, polystyrene, polyaramid, e.g., KEVLAR®, polytetrafluoroethylene (TEFLON®) (both trademarks of E. I. du Pont de Nemours Company, Delaware), fiberglass, polytrimethylene, polycarbonate, polyethylene terephthalate, polyester terephthalate, polybutylene terephthalate, or a combination thereof. In some examples, the synthetic fiber can be a modified fiber from the above-listed polymers. The term “modified fiber” refers to one or both of the polymeric fiber and the fabric as a whole having undergone a chemical or physical process such as, but not limited to, a copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation. The term “PVC-free fibers” as used herein means that no polyvinyl chloride (PVC) polymer or vinyl chloride monomer units are in the fibers.

As previously mentioned, the fabric substrate can be a combination of fiber types, e.g. a combination of any natural fiber with another natural fiber, any natural fiber with a synthetic fiber, a synthetic fiber with another synthetic fiber, or mixtures of multiple types of natural fibers and/or synthetic fibers in any of the above combinations. In some examples, the fabric substrate can include natural fiber and synthetic fiber. The amount of the individual fiber types can vary. For example, the amount of the natural fiber can vary from about 5 wt % to about 95 wt % and the amount of synthetic fiber can range from about 5 wt % to 95 wt %. In yet another example, the amount of the natural fiber can vary from about 10 wt % to 80 wt % and the synthetic fiber can be present from about 20 wt % to about 90 wt %. In other examples, the amount of the natural fiber can be about 10 wt % to 90 wt % and the amount of synthetic fiber can also be about 10 wt % to about 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa.

In one example, the fabric substrate can have a basis weight ranging from about 10 gsm to about 500 gsm. In another example, the fabric substrate can have a basis weight ranging from about 50 gsm to about 400 gsm. In other examples, the fabric substrate can have a basis weight ranging from about 100 gsm to about 300 gsm, from about 75 gsm to about 250 gsm, from about 125 gsm to about 300 gsm, or from about 150 gsm to about 350 gsm.

In addition, the fabric substrate can contain additives including, but not limited to, colorant, e.g., pigments, dyes, or tints, antistatic agents, brightening agents, nucleating agents, antioxidants, UV stabilizers, fillers, and lubricants, for example. Alternatively, the fabric substrate may be pre-treated in a solution containing the substances listed above before applying other treatments or coating layers.

After the ink composition is jetted on the substrate, the ink composition can be heated by exposure to electromagnetic radiation as explained above. The electromagnetic radiation can be provided by any type of electromagnetic radiation source that produces electromagnetic radiation in the wavelength range of 350 nm to 420 nm. In some examples, the electromagnetic radiation source can have a peak emission wavelength in this range. However, in other examples, the electromagnetic radiation source may have a peak emission wavelength outside this range. Even of the peak emission wavelength is outside the range, the electromagnetic radiation source can still produce enough radiation in the 350 nm to 420 nm range to heat up the ink composition.

In some examples, the electromagnetic radiation source can include UV-light emitting diode (LED) lights, mercury lamps, etc. However, in one example, the UV-curing energy source or light can be a UV-LED light or energy source because it can be more environmentally friendly than mercury vapor UV lamps with often a narrower peak UV wavelength emittable therefrom. In some examples, the electromagnetic radiation source can include UV-LEDs that emit a center emission wavelength from 350 nm to 420 nm, e.g., about 365 nm or about 395 nm. In other words, the wavelength can be a relatively narrow band within a range about the center emission wavelength, but the peak wavelength of the narrow band UV range can be one of those set forth above, for example. The narrow band of wavelengths that may surround the center emission wavelength may be about 10 nm to about 50 nm, or from about 15 to about 35 nm, for example. In other examples, the electromagnetic radiation source can be an energy source that emits a wavelength at a peak wavelength or within a range peaking within the 240 nm to 440 nm range, or from 360 nm to 420 nm, for example. This may be a UV-LED energy source, or some other energy source. An example of a UV energy source that can be used that also emits UV energy is a mercury vapor energy source, such as a mercury vapor lamp that may emit high intensity light at wavelengths from 240 nm to 270 nm or from 350 nm to 380 nm. In further examples, the electromagnetic radiation source can include a UV-LED that has a center emission wavelength of 365 nm, 385 nm, 395 nm, 405 nm, or combinations of such LEDs.

The rate at which the evaporable solvent evaporates from the ink composition can be related to the intensity of the electromagnetic radiation applied, in some examples. The intensity can be adjusted by selecting an electromagnetic radiation source with a desired power, or by adjusting the brightness of the electromagnetic radiation source, and so on. In certain examples, the ink composition printed on the substrate can be exposed to electromagnetic radiation at a power density from 0.5 W/cm² to 20 W/cm², or from 1 W/cm² to 15 W/cm², or from 2 W/cm² to 10 W/cm². In further examples, the total amount of evaporable solvent that is evaporated from the ink composition can be affected by the power of the electromagnetic radiation and also by the length of time that the ink composition is exposed to the electromagnetic radiation. In other words, the total amount of evaporable solvent that is removed can be affected by the total energy applied by the electromagnetic radiation. In some examples, the total energy applied by the electromagnetic radiation can be from 0.3 J/cm² to 3 J/cm², or from 0.5 J/cm² to 2.5 J/cm², or from 0.8 J/cm² to 2 J/cm². In certain examples, multiple print passes can be performed and the ink composition printed in the individual print passes can be irradiated with these amounts of energy. Thus, the overall total amount of energy applied can be more when multiple print passes are performed. In further examples, the total amount of energy applied can be adjusted by changing the speed at which the electromagnetic radiation source travels over the substrate, or the speed at which the substrate moves if the substrate is moving past the electromagnetic energy source. In certain examples, the electromagnetic radiation source can include a row of UV-LEDs that can move over the substrate, or a stationary row of UV-LEDs that can be used with a moving substrate. In such examples, the total amount of energy applied by the electromagnetic radiation source can be increased by adding additional rows of UV-LEDs. In other examples, the total amount of energy applied by UV-LEDs can be adjusted by pulsing the UV-LEDs to effectively change the power provided by the UV-LEDs.

As mentioned above, in some examples the methods described herein can be used to print the ink composition without applying any fixer composition to the substrate. Fixer compositions can be any chemical that reacts with the ink composition to cause the colorant in the ink composition to remain on the surface of the substrate when the ink composition is printed. Fixer compositions can include metal salts that can help fix pigments on the substrate. Non-limiting examples of metal salt fixers can include salts of metal cations such as Ca²⁺, Cu²⁺, Ni²⁺, Mg²⁺, Zn²⁺Ba²⁺, Al³⁺, Fe³⁺ or Cr³⁺ with anions such as Cl⁻, I⁻, Br⁻, NO₃⁻ or RCOO⁻ (where R is H or any hydrocarbon chain). Accordingly, in some examples the method does not include applying such a composition to the substrate before or after printing the ink composition.

In further examples, the method can be performed without applying a crosslinker composition to the substrate. Crosslinker compositions are sometimes applied onto the fabric substrate before jetting an ink to crosslink the binder of the ink. However, the ink compositions described herein can be non-curable, and in some examples the inks can be used without a crosslinker composition. Crosslinker compositions can include a crosslinker that is reactive with the binder of the ink composition to crosslink the binder. In some examples, the crosslinker can include blocked isocyanates, polycarbondiimides or polymeric azetidinium salts. Accordingly, in some examples, the methods described herein can be performed without applying such a composition to the substrate.

### Textile Printing Systems

The methods of printing described herein can be performed by textile printing systems in some examples. FIG. 2 shows an example textile printing system 200 including a fabric substrate 210, an inkjet printhead 220 to jet an ink composition 222 onto the fabric substrate, an ink reservoir 224, and an electromagnetic radiation source 230. The ink reservoir is connected in fluid communication with the inkjet printhead, and the ink reservoir contains a supply of the ink composition. As described above, the ink composition can include an evaporable solvent, a colorant, and a non-curable polymeric binder. The electromagnetic radiation source has a center emission wavelength from 350 nm to 420 nm and is positioned to expose the ink composition jetted onto the fabric substrate to electromagnetic radiation from 0 ms to 600 ms after the ink composition is jetted onto the fabric substrate. The electromagnetic radiation can be sufficient to heat the ink composition to evaporate a portion of the evaporable solvent from the ink composition within 5 ms to 500 ms after the beginning of the exposure.

In some examples, the electromagnetic radiation source can be located near the inkjet printhead so that the electromagnetic radiation source can expose the ink composition to electromagnetic radiation quickly after the ink composition is jetted onto the substrate. For example, the electromagnetic radiation source can be located sufficiently close to the inkjet printhead so that printed ink is exposed to the electromagnetic radiation within 600 ms after printing. In certain examples, the electromagnetic radiation source can be positioned within 15 cm from a nozzle of the inkjet printhead through which the ink composition is jetted. In other examples, the electromagnetic radiation source can be positioned within 12 cm, within 10 cm, within 5 cm, or within 3 cm of the nozzle of the inkjet printhead.

In other examples, the electromagnetic radiation source may be located farther from the inkjet printhead. In order to expose printed ink to the electromagnetic radiation quickly, the printing system can be designed to move the substrate from the inkjet printhead to the electromagnetic radiation source quickly. In some examples, the substrate can move from the inkjet printhead to the electromagnetic radiation source at a speed from 12.7 cm/s (5 inches per second) to 101.6 cm/s (40 inches per second), or from 25.4 cm/s (10 inches per second) to 50.8 cm/s (20 inches per second). In other examples, the electromagnetic radiation source can be designed to move while the substrate remains stationary, and the electromagnetic energy source can move at any of the above speeds. Furthermore, in some examples the speed that the substrate moves relative to the electromagnetic radiation source can change when the printed ink reaches the electromagnetic radiation source. For example, the substrate can move at a fast speed from the inkjet printhead to the electromagnetic radiation source in order to begin exposure of the ink quickly, and then the speed can be adjusted depending on the desired time of exposure. In certain examples, the substrate can move at a relatively faster speed while the printed ink is travelling from the inkjet printhead to the electromagnetic radiation source, and then the substrate can move at a relatively slower speed while the printed ink is being exposed to the electromagnetic radiation.

### Inkjet Printers

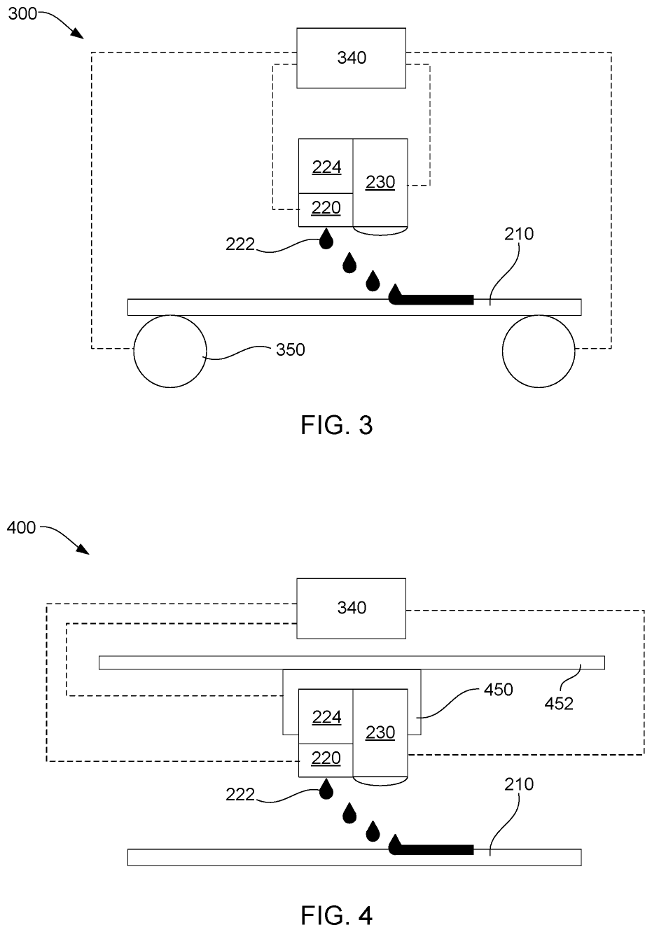

The present disclosure also describes printers that can be used to perform the methods of printing described herein. The printers can be used to print on any type of printing substrate, such as paper media or textile media as described above. FIG. 3 shows an example printer 300 that includes an inkjet printhead 220, an ink reservoir 224 containing an ink composition 222 connected in fluid communication with the inkjet printhead, an electromagnetic radiation source 230, and a hardware controller 340. The hardware controller can generate a command to direct the inkjet printhead to jet the ink composition onto a substrate and to direct the electromagnetic radiation source to expose the ink composition on the substrate to electromagnetic radiation. The exposure of the ink composition can begin from 0 ms to 600 ms after jetting the ink composition. The electromagnetic radiation can heat the ink composition to evaporate a portion of the evaporable solvent from the ink composition within 5 ms to 500 ms after the beginning of the exposure. In this example, the printer includes rollers 350 to move the substrate past the printhead and electromagnetic radiation source. The dashed lines connecting the hardware controller to the printhead, electromagnetic radiation source, and rollers represent connections that allow the hardware controller to direct these components of the printer as described above. In this example, the hardware controller can direct the rollers to move the substrate past the printhead and electromagnetic radiation source at a desired speed while directing the printhead to print the ink composition and directing the electromagnetic radiation source to irradiate the ink printed on the substrate. The hardware controller can adjust the total amount of radiation energy applied to the ink by changing the speed of the substrate, the intensity of the electromagnetic radiation source, or a combination thereof.

As mentioned above, in some examples the electromagnetic radiation source can be positioned near the inkjet printhead so that the ink jetted from the inkjet printhead can be exposed to electromagnetic radiation quickly to pin the ink composition on the substrate. The printer can have various designs for positioning the inkjet printhead and the electromagnetic radiation source. In some examples, the inkjet printhead and the electromagnetic radiation source can be stationary. The printer can move the substrate past the inkjet printhead and the electromagnetic radiation source using rollers or a similar mechanism for moving the substrate. In certain examples, the inkjet printhead can be sized to print across and entire width of the substrate or nearly the entire width of the substrate. The substrate can then be moved past the inkjet printhead and the entire or nearly entire area of the substrate can be printed in a single pass. The electromagnetic radiation source can also be sized to expose the entire width of the substrate to electromagnetic radiation as the substrate is moved past. For example, a row of UV-LEDs may be positioned behind the inkjet printhead so that the substrate is exposed to electromagnetic radiation after the ink composition is jetted onto the substrate.

In other examples, the printer can include a carriage and the electromagnetic radiation source and the inkjet printhead can be positioned on the carriage. The carriage (also sometimes referred to as a “cradle”) can be a mechanism that holds the inkjet printhead and moves laterally across the print substrate to allow a relatively small printhead to print ink across an entire width of the substrate. In some examples, the printer can include a carriage that carries the inkjet printhead across the substrate in one direction, and also a mechanism to move the substrate in another direction. In certain examples, the carriage can move laterally from side to side across the substrate, while the printer can also feed the substrate through the printer in a back-to-front or front-to-back direction. By combining these motions, a small inkjet printhead can be used to print over the entire area of the substrate. In order to apply electromagnetic radiation to the jetted ink composition quickly, in some examples the electromagnetic radiation source can be placed on the carriage next to the inkjet printhead. The carriage can move so that the ink jetted from the inkjet printhead is exposed to electromagnetic radiation soon after being jetted. In certain examples, two electromagnetic radiation sources can be located on the carriage, on both sides of the inkjet printhead. This can allow the inkjet printhead to print ink while the carriage is moving in either direction and one of the electromagnetic radiation sources can be used to expose the ink to radiation quickly after the ink is printed.

FIG. 4 shows another example printer 400 that includes an inkjet printhead 220 and an electromagnetic radiation source 230 that are both on a carriage 450. A substrate 210 is loaded in the printer in this example. As explained above, the carriage can move the inkjet printhead and the electromagnetic radiation source from side to side along a track 452 while the inkjet printhead jets ink composition 222 onto the substrate. This figure also shows dashed lines connecting the hardware controller 340 to the printhead, the electromagnetic radiation source, and the carriage. The hardware controller can direct the carriage to move at a desired speed while the printhead prints the ink composition and the electromagnetic radiation source irradiates the ink composition. In further examples, the printer can also include rollers or another mechanism for moving the substrate. For example, the printer can move the substrate in a front-to-back direction while the carriage moves the printhead and electromagnetic radiation source in a side-to-side direction.

### Ink Compositions

A wide variety of inks can be used with the methods and systems described herein. In certain examples, the ink composition can be formulated to provide good durability when printed on textile substrates. As mentioned above, in some examples the ink composition can include a polymeric binder. The polymeric binder can help increase the viscosity of the ink composition when the evaporable solvent evaporates, so that the ink is pinned on place on the surface of the substrate. The polymeric binder can also contribute to the durability and washfastness of the ink after printing.

A variety of polymeric binders can be used in the ink composition. In some examples, the polymeric binder can include a polymer latex, a polyurethane dispersion, or a hybrid copolymer of polymer latex and polyurethane. The polymer latex can have a glass transition temperature from −30° C. to 130° C., or from −20° C. to 100° C. in some examples. The monomers used in the latexes can include vinyl monomers. In one example, the monomers can include vinyl monomers such as vinyl chloride, vinylidene chloride, etc., vinyl ester monomers, acrylate monomers, methacrylate monomers, styrene monomers, ethylene, maleate esters, fumarate esters, and itaconate esters, or combinations thereof. In one example, the monomers can include acrylates, methacrylates, styrenes, or mixtures thereof. The monomers can likewise include hydrophilic monomers including acid monomers, and hydrophobic monomers. Other examples of monomers that can be polymerized in forming the latexes can include styrene, n-methyl styrene, p-methyl styrene, methyl methacrylate, hexyl acrylate, hexyl methacrylate, butyl acrylate, butyl methacrylate, ethyl acrylate, ethyl methacrylate, propyl acrylate, propyl methacrylate, 2-ethylhexyl acrylate, 2-ethylhexyl methacrylate, octadecyl acrylate, octadecyl methacrylate, stearyl methacrylate, vinylbenzyl chloride, isobornyl acrylate, tetrahydrofurfuryl acrylate, 2-phenoxyethyl methacrylate, benzyl methacrylate, benzyl acrylate, ethoxylated nonyl phenol methacrylate, isobornyl methacrylate, cyclohexyl methacrylate, trimethyl cyclohexyl methacrylate, t-butyl methacrylate, n-octyl methacrylate, lauryl methacrylate, trydecyl methacrylate, alkoxylated tetrahydrofurfuryl acrylate, isodecyl acrylate, isobornylmethacrylate, isobornyl acrylate, dimethyl maleate, dioctyl maleate, acetoacetoxyethyl methacrylate, diacetone acrylamide, N-vinyl imidazole, N-vinylcarbazole, N-Vinyl-caprolactam, combinations thereof, derivatives thereof, or mixtures thereof. Acidic monomers that can be polymerized in forming latexes include, without limitation, acrylic acid, methacrylic acid, ethacrylic acid, dimethylacrylic acid, maleic anhydride, maleic acid, vinylsulfonate, cyanoacrylic acid, vinylacetic acid, allylacetic acid, ethylidineacetic acid, propylidineacetic acid, crotonoic acid, fumaric acid, itaconic acid, sorbic acid, angelic acid, cinnamic acid, styrylacrylic acid, citraconic acid, glutaconic acid, aconitic acid, phenylacrylic acid, acryloxypropionic acid, aconitic acid, phenylacrylic acid, acryloxypropionic acid, vinylbenzoic acid, N-vinylsuccinamidic acid, mesaconic acid, methacroylalanine, acryloylhydroxyglycine, sulfoethyl methacrylic acid, sulfopropyl acrylic acid, styrene sulfonic acid, sulfoethylacrylic acid, 2-methacryloyloxymethane-1-sulfonic acid, 3-methacryoyloxypropane-1-sulfonic acid, 3-(vinyloxy)propane-1-sulfonic acid, ethylenesulfonic acid, vinyl sulfuric acid, 4-vinylphenyl sulfuric acid, ethylene phosphonic acid, vinyl phosphoric acid, vinyl benzoic acid, 2-acrylamido-2-methyl-1-propanesulfonic acid, derivatives thereof, or combinations thereof.

Regarding the latex particulates, the latexes can have various shapes, sizes, and molecular weights. In one example, the latex particulates may have a weight average molecular weight (Mw) of 5,000 Mw to 500,000 Mw. In one aspect, the latex particulates can have a weight average molecular weight (Mw) ranging from 100,000 Mw to 500,000 Mw. In some other examples, the latex can have a weight average molecular weight of 150,000 Mw to 300,000 Mw. Further, the average particle diameter of the latex particles can be from 10 nm to 1 μm; in some other examples, from 10 nm to 500 nm; and, in yet other examples, from 50 nm to 300 nm. The particle size distribution of the latex is not particularly limited, and either latex having a broad particle size distribution or latex having a mono-dispersed particle size distribution may be used. It is also possible to use two or more kinds of latex particles that have a mono-dispersed particle size distribution in combination.

In some examples, the polymeric binder used in the ink composition can be a polyurethane or polyurethane derivative such as vinyl-urethane, acrylic urethane, polyurethane-acrylic, polyether polyurethane, polyester polyurethane, polycaprolactam polyurethane, polyether polyurethane, or combinations thereof. The weight average molecular weight of the polyurethane polymeric binder can range from 20,000 Mw to 200,000 Mw in some examples. The weight average molecular weight can be measured by gel permeation chromatography with the polystyrene standard. In another example, the weight average molecular weight of the polyurethane polymeric binder can range from 40,000 Mw to 180,000 Mw as measured by gel permeation chromatography. In yet another example, the weight average molecular weight of the polyurethane polymeric binder can range from 60,000 Mw to 140,000 Mw as measured by gel permeation chromatography.

The polyurethane may be aliphatic or aromatic. Some specific examples of commercially available aliphatic waterborne polyurethanes include SANCURE® 1514, SANCURE® 1591, SANCURE® 2260, and SANCURE® 2026 (all of which are available from Lubrizol Inc., USA). Some specific examples of commercially available castor oil-based polyurethanes include ALBERDINGKUSA® CUR 69, ALBERDINGKUSA® CUR 99, and ALBERDINGKUSA® CUR 991 (all from Alberdingk Boley Inc., Germany).

In some examples, any example of the polymeric compound can include a polyether polyurethane. Commercially available examples of the chemicals which can form a polyether-urethane include ALBERDINGKUSA U 205, ALBERDINGKUSA U 410, and ALBERDINGKUSA U 400N (all from Alberdingk Boley Inc., Germany), or SANCURE®861, SANCURE® 878, SANCURE® 2310, SANCURE® 2710, SANCURE® 2715, or AVALURE® UR445 (all from Lubrizol Inc., USA).

Additional examples of commercially available polymers that can be used in the polymeric binder can include ALBERDINGKUSA® 801, ALBERDINGKUSA u 910, ALBERDINGKUSA u 9380, ALBERDINGKUSA® 2101 and ALBERDINGKUSA® 420 (all from Alberdingk Boley Inc., Germany), or SANCURE® 815, SANCURE 825, SANCURE® 835, SANCURE 843c, SANCURE® 898, SANCURE® 899, SANCURE® 1301, SANCURE® 1511, SANCURE 2026c, SANCURE® 2255, and SANCURE® 2310 (all from Lubrizol, Inc., USA). In still other examples, any example of the polymeric compound can include a polycarbonate polyurethane. Examples of polycarbonate polyurethanes include ALBERDINGKUSA U 933 and ALBERDINGKUSA U 915 (all from Alberdingk Boley Inc., Germany).

In some examples, the polymeric binders that can be used include vinyl-urethane, acrylic urethane, polyurethane-acrylic hybrid copolymers or acrylic-urethane hybrid copolymers. For example, the polymeric binders can include an aliphatic polyurethane-acrylic hybrid polymer. Commercially available examples of the chemicals which can form an acrylic-urethane polymeric network include NEOPAC®R-9000, R-9699 and R-9030 (from Zeneca Resins, United Kingdom) or HYRBIDUR™ 570 (from Air Products and Chemicals, USA). In still another example, the polymeric binder can include an acrylic-polyester-polyurethane polymer, such as SANCURE® AU 4010 (from Lubrizol Inc., USA).

In certain examples, the polymeric binder can include a polyurethane formed by polymerizing a diisocyanate with a polyol. In some examples, multiple different diisocyanate compounds and/or multiple different polyols can be polymerized together. Accordingly, the polyurethane can include polymerized monomers including polymerized diisocyanates and polymerized polyols. As used herein, “polymerized” is used with respect to monomers or segments of polymers to describe the monomers or segments of polymers in their polymerized state, e.g., after the monomers have bonded together to form a polymer chain. The names of monomers in their original state may be used even though it is understood that the monomers change in certain ways during polymerizing. For example, “polymerized diisocyanate and polyol” can refer to a polymer chain formed by polymerizing a diisocyanate and a polyol, even though the diisocyanate and polyol do not actually exist as separate molecules in the polymer. In the case of polymerized diisocyanates and polyols, a hydrogen atom of the hydroxyl group of the polyol is replaced by a bond between the oxygen atom of the hydroxyl group and the carbon atom of the isocyanate group of the diisocyanate. Thus, the polyol is no longer a polyol, but has become a portion of a polymer chain. However, “polymerized polyol” may still be used to refer to this portion of the polymer chain for the sake of convenience. The portions of the polymer chain formed from diisocyanates or polyols can also be referred to as “diisocyanate units” and “polyol units” for convenience.

In some examples, diisocyanates and polyols can polymerize to form pre-polymer segments, and the pre-polymer segments can react with a chain extender to form the polyurethane binder. Pre-polymer segments can also be described as being polymerized because the pre-polymer segments can react with chain extenders to form longer polymer chains. After formation of the longer polymer chain, the pre-polymer segment and the chain extender compounds no longer exist as independent molecules. However, these can be referred to as “polymerized pre-polymer segments” and “polymerized chain extenders” for convenience.

In certain examples, a polyurethane binder can be formed by the following process. A pre-polymer segment can be formed by the reaction of a diisocyanate and a polymeric polyol. The polymeric polyol can include, for example, a polyester polyol, polycarbonate polyol, polyether polyol, or a combination thereof. In this reaction, the isocyanate groups of the diisocyanate can react with hydroxyl groups of the polyols to link the monomers together. More specifically, a hydrogen atom from a hydroxyl group of the polyol is replaced by a bond between the oxygen atom of the hydroxyl group and the carbon atom of an isocyanate group of the diisocyanate. This results in a “urethane linkage” joining together the diisocyanate and the polyol. Thus, the pre-polymer segment can include alternating diisocyanate and polyol units. In some examples, these monomers can be mixed together simultaneously, and this can result in random polymerization. In further examples, an excess of the diisocyanate can be added to this reaction so that the product of the reaction can be pre-polymer segments that terminate is diisocyanate units at either end. Thus, the pre-polymer segments can have an unreacted isocyanate group at both ends that are available to react with additional monomers.

After forming the pre-polymer segments, a chain extender can be added. In some examples, the chain extender can include a sulfonate-containing diamine. In further examples, the chain extender can include a mixture of a sulfonate-containing diamine and a non-acid-containing diamine. The diamines can include two amino groups that can react with the unreacted isocyanate groups at the ends of pre-polymer segments. Thus, a single diamine molecule can react with isocyanate groups on two different pre-polymer segments to link the pre-polymer segments together. The sulfonate group of the sulfonate-containing diamine can help make the polyurethane polymer more water-dispersible.

In some examples, the diisocyanate, polyols, and chain extenders described above can react in the presence of an organic solvent. After the polyurethane chain is complete, water can be added, and the organic solvent can be removed to form an aqueous dispersion of the polyurethane binder. In further examples, an excess of diisocyanate can be used when forming the polyurethane chains so that some unreacted isocyanate groups remain in the polyurethane binder dispersion. In certain examples, the polyurethane binder dispersion can have a D50 particle size from about 10 nm to about 400 nm.

In certain examples, the diisocyanate polymerized in the pre-polymer segment can be selected from the following diisocyanates:

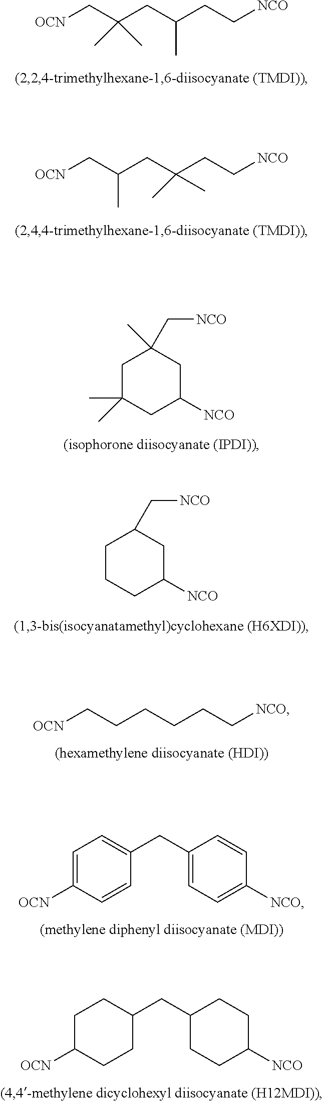

or a combination thereof.

The diisocyanate can be reacted with a polyol or multiple different polyols, such as polymeric polyols. In some examples, polymeric polyols can have a polymer chain with hydroxyl groups at or near the ends of the polymer chain. For example, a first terminal hydroxyl group can be at a first end of the polymeric polyol and a second terminal hydroxyl group can be at a second end of the polymeric polyol. Although in some examples the polymeric polyol can have exactly two hydroxyl groups, in other examples the polymeric polyol can have additional hydroxyl groups. Therefore, polymeric polyols having two or more hydroxyl groups can be polymerized in the pre-polymer segments of the polyurethane binder. In some examples, the polymeric polyol can include polyether polyols, polyester polyols, polycarbonate polyols, or combinations thereof. Non-limiting examples of commercially available polymeric polyols can include the following polyols available from Stepan Company (Ilinois): STEPANOL® bc-180, STEPANOL® PC-1011-45, STEPANOL® PC-1011-55, STEPANOL® PC-1011P-110, STEPANOL® PC-1011P-210, STEPANOL® PC-1015-55, STEPANOL® PC-1015P-120, STEPANOL® PC-1017P-55, STEPANOL® PC-101P-55, STEPANOL® PC-102-140, STEPANOL® PC-1021P-70, STEPANOL® PC-102-56, STEPANOL® PC-1028-115, STEPANOL® PC-1028P-210, STEPANOL® PC-1035-55, STEPANOL® PC-1040-55, STEPANOL® PC-1040P-55, STEPANOL® PC-105-10, STEPANOL® PC-105P-110, STEPANOL® PC-105P-30, STEPANOL® PC-107-110, STEPANOL® PC-107P-55, STEPANOL® PC-2011-225, STEPANOL® PC-2011-45, STEPANOL® PC-201-165, STEPANOL® PC-2019-35, STEPANOL® PC-2019-55, STEPANOL® PC-201P-110, STEPANOL® PC-205P-160, STEPANOL® PC-205P-20, STEPANOL® PC-205P-30, STEPANOL® PC-205P-56, STEPANOL® PC-207-125, STEPANOL® PC-2072P-30, STEPANOL® PC-5000P-30, STEPANOL® PC-5010P-35, STEPANOL® PC-5020-130, STEPANOL® PC-5020-160, STEPANOL® PC-5030-270, STEPANOL® PC-5040-167, STEPANOL® PC-5050P-60, STEPANOL® PC-5070P-56, STEPANOL® PC-5080-215, STEPANOL® PC-5080-285, STEPANOL® PC-5100P-56, STEPANOL® PC-5110-58, STEPANOL® PC-5120P-20, STEPANOL® PC-5130-160, STEPANOL® PD-195, STEPANOL® PD-320, STEPANOL® PD-56, STEPANOL® PDC-279, STEPANOL® PDP-70, STEPANOL® PH-56, and STEPANOL® PHN-56. Additional examples of polymeric polyols can include polyols available from Kuraray America, Inc. (USA), including KURARAY™ C-590, KURARAY™ C-1090, KURARAY™ C-2090, and KURARAY™ C-3090.

In some examples, the diisocyanate and the various polyols can react together to form pre-polymer segments having isocyanate groups at one or both ends of the pre-polymer segments. In certain examples, the pre-polymer segments can be formed with an NCO/OH ratio from about 1 to about 10. In further examples, the NCO/OH ratio can be from about 1.2 to about 10 or from about 2 to about 3. As used herein, “NCO/OH ratio” refers to the mole ratio of NCO groups to OH groups in the monomers that react to form the pre-polymer segment.

The pre-polymer segments can be formed by polymerizing the diisocyanate and polyol described above. In some examples, the polymerization can be accomplished by mixing the monomers in the presence of an organic solvent and a catalyst. In certain examples, the catalyst can be dibutyl tin dilaurate (DBTDL). After polymerizing the pre-polymer segments, the pre-polymer segments can be linked together by adding a chain extender. The chain extender can include two reactive groups that can react with isocyanate groups at the ends of the pre-polymer segments.

As mentioned above, in some examples the chain extender can include a sulfonate-containing diamine. The sulfonate-containing diamine can have two amino groups that react with isocyanate groups at the ends of the pre-polymer segments. The sulfonate group can be an anionic group that can help make the polyurethane binder more water dispersible. In certain examples, the sulfonate-containing diamine can be 2-((2-aminoethyl)amino)ethanesulfonate or a salt thereof. In one example, the sulfonate-containing diamine can include A-95™ available from Evonik (Germany).

In further examples, polyurethane binder can have an acid number from 10 mg KOH/g to 100 mg KOH/g. In other examples, the polyurethane binder can have an acid number from 10 mg KOH/g to 60 mg KOH/g or from 10 mg KOH/g to 30 mg KOH/g.

The polyurethane binder can be formed into a dispersion having polyurethane particles dispersed in an aqueous vehicle. As mentioned above, the polyurethane binder can be polymerized by mixing monomers in an organic solvent. After the polymerization, water can be added and/or organic solvent can be removed to form an aqueous dispersion of the polyurethane binder. In some examples, the polyurethane binder dispersion can have a D50 particle size from 10 nm to 400 nm. In other examples, the D50 particle size can be from 15 nm to 100 nm, or from 20 nm to 50 nm.

The polymeric binder, whether polyurethane or another type of polymer, can be included in the ink composition in any amount that does not interfere with the jettability of the ink composition. In some examples, the polymeric binder can be present in an amount from about 0.1 wt % to about 30 wt % with respect to the total weight of the ink composition. In further examples, the polymeric binder can be present in an amount from about 0.1 wt % to about 15 wt %, or from about 0.5 wt % to about 10 wt %, or form about 0.6 wt % to 5 wt %, with respect to the total weight of the ink composition.

As mentioned above, the ink compositions can a colorant. In some examples, the colorant can include a pigment. In some examples, pigment can be included in an amount from about 0.5 wt % to about 15 wt %, or from about 1 wt % to about 10 wt %, or from about 5 wt % to about 10 wt %, based on the total weight of the ink composition.

The pigment can be any of a number of pigments of any of a number of colors, or can be black or white, for example. More specifically, colors can include cyan, magenta, yellow, red, blue, violet, red, orange, green, etc. In one example, the ink composition can be a black ink with a carbon black pigment. In another example, the ink composition can be a cyan or green ink with a copper phthalocyanine pigment, e.g., Pigment Blue 15:0, Pigment Blue 15:1; Pigment Blue 15:3, Pigment Blue 15:4, Pigment Green 7, Pigment Green 36, etc. In another example, the ink composition can be a magenta ink with a quinacridone pigment or a co-crystal of quinacridone pigments. Example quinacridone pigments that can be utilized can include PR122, PR192, PR202, PR206, PR207, PR209, PO48, PO49, PV19, PV42, or the like. These pigments tend to be magenta, red, orange, violet, or other similar colors. In one example, the quinacridone pigment can be PR122, PR202, PV19, or a combination thereof. In another example, the ink composition can be a yellow ink with an azo pigment, e.g., PY74 and PY155. Other examples of pigments include the following, which are available from BASF Corp.: PALIOGEN® Orange, HELIOGEN® Blue L 6901F, HELIOGEN® Blue NBD 7010, HELIOGEN® Blue K 7090, HELIOGEN® Blue L 7101F, PALIOGEN® Blue L 6470, HELIOGEN® Green K 8683, HELIOGEN® Green L 9140, CHROMOPHTAL® Yellow 3G, CHROMOPHTAL® Yellow GR, CHROMOPHTAL® Yellow 8G, IGRAZIN® Yellow 5GT, and IGRALITE® Rubine 4BL. The following pigments are available from Degussa Corp.: Color Black FWI, Color Black FW2, Color Black FW2V, Color Black 18, Color Black, FW200, Color Black 5150, Color Black S160, and Color Black 5170. The following black pigments are available from Cabot Corp.: REGAL® 400R, REGAL® 330R, REGAL® 660R, MOGUL® L, BLACK PEARLS® L, MONARCH® 1400, MONARCH® 1300, MONARCH® 1100, MONARCH® 1000, MONARCH® 900, MONARCH® 880, MONARCH® 800, and MONARCH® 700. The following pigments are available from Orion Engineered Carbons GMBH: PRINTEX® U, PRINTEX® V, PRINTEX® 140U, PRINTEX® 140V, PRINTEX® 35, Color Black FW 200, Color Black FW 2, Color Black FW 2V, Color Black FW 1, Color Black FW 18, Color Black S 160, Color Black S 170, Special Black 6, Special Black 5, Special Black 4A, and Special Black 4. The following pigment is available from DuPont: TI-PURE® R-101. The following pigments are available from Heubach: MONASTRAL® Magenta, MONASTRAL® Scarlet, MONASTRAL® Violet R, MONASTRAL® Red B, and MONASTRAL® Violet Maroon B. The following pigments are available from Clariant: DALAMAR® Yellow YT-858-D, Permanent Yellow GR, Permanent Yellow G, Permanent Yellow DHG, Permanent Yellow NCG-71, Permanent Yellow GG, Hansa Yellow RA, Hansa Brilliant Yellow 5GX-02, Hansa Yellow-X, NOVOPERM® Yellow HR, NOVOPERM® Yellow FGL, Hansa Brilliant Yellow 10GX, Permanent Yellow G3R-01, HOSTAPERM® Yellow H4G, HOSTAPERM® Yellow H3G, HOSTAPERM® Orange GR, HOSTAPERM® Scarlet GO, and Permanent Rubine F6B. The following pigments are available from Sun Chemical: QUINDO® Magenta, INDOFAST® Brilliant Scarlet, QUINDO® Red R6700, QUINDO® Red R6713, INDOFAST® Violet, L74-1357 Yellow, L75-1331 Yellow, L75-2577 Yellow, and LHD9303 Black. The following pigments are available from Birla Carbon: RAVEN® 7000, RAVEN® 5750, RAVEN® 5250, RAVEN® 5000 Ultra® II, RAVEN® 2000, RAVEN® 1500, RAVEN® 1250, RAVEN® 1200, RAVEN® 1190 Ultra®. RAVEN® 1170, RAVEN® 1255, RAVEN® 1080, and RAVEN® 1060. The following pigments are available from Mitsubishi Chemical Corp.: No. 25, No. 33, No. 40, No. 47, No. 52, No. 900, No. 2300, MCF-88, MA600, MA7, MA8, and MA100. The colorant may be a white pigment, such as titanium dioxide, or other inorganic pigments such as zinc oxide and iron oxide.

Specific other examples of a cyan color pigment may include C.I. Pigment Blue-1, -2, -3, -15, -15:1, -15:2, -15:3, -15:4, -16, -22, and -60; magenta color pigment may include C.I. Pigment Red-5, -7, -12, -48, -48:1, -57, -112, -122, -123, -146, -168, -177, -184, -202, and C.I. Pigment Violet-19; yellow pigment may include C.I. Pigment Yellow-1, -2, -3, -12, -13, -14, -16, -17, -73, -74, -75, -83, -93, -95, -97, -98, -114, -128, -129, -138, -151, -154, and -180. Black pigment may include carbon black pigment or organic black pigment such as aniline black, e.g., C.I. Pigment Black 1. While several examples have been given herein, it is to be understood that any other pigment can be used that is useful in color modification, or dye may even be used in addition to the pigment.

Furthermore, pigments and dispersants are described separately herein, but there are pigments that are commercially available which include both the pigment and a dispersant suitable for ink composition formulation. Specific examples of pigment dispersions that can be used, which include both pigment solids and dispersant are provided by example, as follows: HPC-K048 carbon black dispersion from DIC Corporation (Japan), HSKBPG-11-CF carbon black dispersion from Dom Pedro (USA), HPC-0070 cyan pigment dispersion from DIC, CABOJET® 250C cyan pigment dispersion from Cabot Corporation (USA), 17-SE-126 cyan pigment dispersion from Dom Pedro, HPF-M046 magenta pigment dispersion from DIC, CABOJET® 265M magenta pigment dispersion from Cabot, HPJ-Y001 yellow pigment dispersion from DIC, 16-SE-96 yellow pigment dispersion from Dom Pedro, or EMACOL™ SF Yellow AE2060F yellow pigment dispersion from Sanyo (Japan).

Thus, the pigment(s) can be dispersed by a dispersant that is adsorbed or ionically attracted to a surface of the pigment or can be covalently attached to a surface of the pigment as a self-dispersed pigment. In one example, the dispersant can be an acrylic dispersant, such as a styrene (meth)acrylate dispersant, or other dispersant suitable for keeping the pigment suspended in the liquid vehicle. In one example, the styrene (meth)acrylate dispersant can be used, as it can promote π-stacking between the aromatic ring of the dispersant and various types of pigments. In one example, the styrene (meth)acrylate dispersant can have a weight average molecular weight from 4,000 Mw to 30,000 Mw. In another example, the styrene-acrylic dispersant can have a weight average molecular weight of 8,000 Mw to 28,000 Mw, from 12,000 Mw to 25,000 Mw, from 15,000 Mw to 25,000 Mw, from 15,000 Mw to 20,000 Mw, or about 17,000 Mw. Regarding the acid number, the styrene (meth)acrylate dispersant can have an acid number from 100 mg KOH/g to 350 mg KOH/g, from 120 mg KOH/g to 350 mg KOH/g, from 150 mg KOH/g to 300 mg KOH/g, from 180 mg KOH/g to 250 mg KOH/g, or about 201 mg KOH/g to 220 mg KOH/g, for example. Example commercially available styrene-acrylic dispersants can include JONCRYL® 671, JONCRYL® 71, JONCRYL® 96, JONCRYL® 680, JONCRYL® 683, JONCRYL® 678, JONCRYL® 690, JONCRYL® 296, JONCRYL® 671, JONCRYL® 696 or JONCRYL® ECO 675 (all available from BASF Corp., Germany).

The term “(meth)acrylic” refers to monomers, copolymerized monomers, etc., that can either be acrylate or methacrylate (or a combination of both), or acrylic acid or methacrylic acid (or a combination of both), as the acid or salt/ester form can be a function of pH. Furthermore, even if the monomer used to form the polymer was in the form of a (meth)acrylic acid during preparation, pH modifications during preparation or subsequently when added to an ink composition can impact the nature of the moiety as well (acid form vs. salt or ester form). Thus, a monomer or a moiety of a polymer described as (meth)acrylic should not be read so rigidly as to not consider relative pH levels, ester chemistry, and other organic chemistry concepts.

The ink compositions of the present disclosure can be formulated to include a liquid vehicle that includes an evaporable solvent. In some examples, the liquid vehicle can include water, e.g., 30 wt % to 99 wt %, 50 wt % to 95 wt %, 60 wt % to 90 wt % or from 70 wt % to 90 wt %, as well as organic co-solvent, e.g., from 1 wt % to 40 wt %, from 4 wt % to 30 wt %, from 4 wt % to 20 wt %, or from 5 wt % to 15 wt %. Other liquid vehicle components can also be included, such as surfactant, antibacterial agent, other colorant, etc. However, as part of the ink composition used in the systems and methods described herein, the pigment, dispersant, and polymeric binder can be included or carried by the liquid vehicle components. Suitable pH ranges for the ink composition can be from pH 6 to pH 10, from pH 7 to pH 10, from pH 7.5 to pH 10, from pH 8 to pH 10, 6 to pH 9, from pH 7 to pH 9, from pH 7.5 to pH 9, etc.

In further detail regarding the liquid vehicle, the co-solvent(s) can be present and can include any co-solvent or combination of co-solvents that is compatible with the pigment, dispersant, and polymeric binder. Examples of suitable classes of co-solvents include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1,3-propane diol (EPHD), glycerol, dimethyl sulfoxide, sulfolane, glycol ethers, alkyldiols such as 1,2-hexanediol, and/or ethoxylated glycerols such as LEG-1, etc.

The liquid vehicle can also include surfactant and/or emulsifier. The surfactant can be water soluble and may include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, and mixtures thereof. In some examples, the surfactant can include a nonionic surfactant, such as a SURFYNOL® surfactant, e.g., SURFYNOL® 440 (from Evonik, Germany), or a TERGITOL™ surfactant, e.g., TERGITOL™ TMN-6 (from Dow Chemical, USA). In another example, the surfactant can include an anionic surfactant, such as a phosphate ester of a C10 to C20 alcohol or a polyethylene glycol (3) oleyl mono/di phosphate, e.g., CRODAFOS® N3A (from Croda International PLC, United Kingdom). The surfactant or combinations of surfactants, if present, can be included in the ink composition at from about 0.01 wt % to about 5 wt % and, in some examples, can be present at from about 0.05 wt % to about 3 wt % of the ink compositions.

In further examples, the liquid vehicle can include a humectant. Examples include, but are not limited to, alcohols, for example, glycols such as 2,2′-thiodiethanol, glycerol, 1,3-propanediol, 1,5-pentanediol, polyethylene glycol, ethylene glycol, diethylene glycol, propylene glycol and tetraethylene glycol; pyrrolidones such as 2-pyrrolidone; N-methyl-2-pyrrolidone; N-methyl-2-oxazolidinone; and monoalcohols such as n-propanol and iso-propanol. In certain examples, the humectants can include 2,2′-thiodiethanol, glycerol, 1,3-propanediol, 1,5-pentanediol, polyethylene glycol, ethylene glycol, diethylene glycol, propylene glycol, tetraethylene glycol, 2-pyrrolidone, n-propanol or mixtures thereof. In further examples, the humectant can include a mixture of alcohols.

Consistent with the formulations of the present disclosure, various other additives may be included to provide desired properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, ACTICIDE®, e.g., ACTICIDE® B20 (Thor Specialties Inc.), NUOSEPT™ (Nudex, Inc.), UCARCIDE™ (Union carbide Corp.), VANCIDE® (R.T. Vanderbilt Co.), PROXEL™ (ICI America), and combinations thereof. Sequestering agents, such as EDTA (ethylene diamine tetra acetic acid) or trisodium salt of methylglycinediacetic acid, may be included to eliminate the deleterious effects of heavy metal impurities, and buffer solutions may be used to control the pH of the ink. Viscosity modifiers and buffers may also be present, as well as other additives to modify properties of the ink as desired.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable based on experience and the associated description herein.

The term “acid value” or “acid number” refers to the mass of potassium hydroxide (KOH) in milligrams that can be used to neutralize one gram of substance (mg KOH/g), such as the polymeric binders disclosed herein. This value can be determined, in one example, by dissolving or dispersing a known quantity of a material in organic solvent and then titrating with a solution of potassium hydroxide (KOH) of known concentration for measurement.

“D50” particle size is defined as the particle size at which about half of the particles are larger than the D50 particle size and about half of the other particles are smaller than the D50 particle size (by weight based on the metal particle content of the particulate build material). As used herein, particle size with respect to the polyurethane binder particles can be based on volume of the particle size normalized to a spherical shape for diameter measurement, for example. Particle size can be collected using a Malvern ZETASIZER™ from Malvern Panalytical (United Kingdom), for example. Likewise, the “D95” is defined as the particle size at which about 5 wt % of the particles are larger than the D95 particle size and about 95 wt % of the remaining particles are smaller than the D95 particle size. Particle size information can also be determined and/or verified using a scanning electron microscope (SEM) or can be measured using a particle analyzer such as the MASTERSIZER™ 3000 available from Malvern Panalytical, for example. The particle analyzer can measure particle size using laser diffraction. A laser beam can pass through a sample of particles and the angular variation in intensity of light scattered by the particles can be measured. Larger particles scatter light at smaller angles, while small particles scatter light at larger angles. The particle analyzer can then analyze the angular scattering data to calculate the size of the particles using the Mie theory of light scattering. The particle size can be reported as a volume equivalent sphere diameter.

As used herein, a plurality of items, structural elements, compositional elements, and/or materials may be presented in a common list for convenience. However, these lists should be construed as though the members of the list are individually identified as separate and unique members. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, and also to include all the individual numerical values or sub-ranges encompassed within that range as if the numerical values and sub-ranges are explicitly recited. For example, a weight ratio range of about 1 wt % to about 20 wt % should be interpreted to include the explicitly recited limits of about 1 wt % and about 20 wt %, and also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following is merely illustrative of the methods and systems herein. Numerous modifications and alternative methods and systems may be devised without departing from the present disclosure. Thus, while the technology has been described above with particularity, the following provides further detail in connection with what are presently deemed to be the acceptable examples.

### Example 1—Synthesis of Polyurethane Binder

A polyurethane binder was synthesized for use as the binder in a sample ink composition. To form the polyurethane, 72.620 grams of a polyester polyol (STEPANOL® PC-1015-55; Stepan Company, USA) and 20.570 grams of isophorone diisocyanate (IPDI) in 80 grams of acetone were mixed in a 500 mL 4-neck round bottom flask. A mechanical stirrer with glass rod and TEFLON® (Chemours, USA) blade was attached. A condenser was attached. The flask was immersed in a constant temperature bath at 75° C. The system was kept under a drying tube. 3 drops of dibutyl tin dilaurate (DBTDL) were added to initiate the polymerization. Polymerization was continued for 6 hours at 75° C. A 0.5 gram sample was withdrawn for testing wt % NCO titration to confirm the reaction. The measured NCO value was 5.10 wt %. Theoretical wt % NCO should have been 5.13 wt %. The polymerization temperature was reduced to 50° C. 3.830 grams of 2,2,4 (or 2, 4, 4)-trimethylhexane-1,6-diamine (TMDA), 5.941 grams of sodium aminoalklysulphonate (A-95™, Evonik, Germany, 50% in water) and 14.819 grams of deionized water were mixed in a beaker until the TMD and A-95™ were completely dissolved. The TMD and A-95™ solution was added to the pre-polymer solution at 50° C. with vigorous stirring over 5 minutes. The solution became viscous and slight hazy. The mixture was stirred for 30 minutes at 50° C. Then 201.713 grams of deionized water was added to polymer mixture in the 4-neck round bottom flask over 10 minutes with good agitation to form the polyurethane dispersion. The agitation was continued for 60 minutes at 50° C. The polyurethane dispersion was filtered through a 400 mesh stainless steel sieve. Acetone was removed with Rotorvap at 50° C. (adding 2 drops (20 mg) of BYK™-011 de-foaming agent, BYK, Germany). The final polyurethane dispersion was filtered through fiber glass filter paper. Particle size measured by Malvern ZETASIZER™ (Malvern Panalytical, Unite Kingdom) was 156.8 nm. The pH was 7. The solids content was 34.5%.

### Example 2—Ink Compositions

Yellow and black sample ink compositions were formulated by mixing 6 wt % of the polyurethane dispersion from Example 1, 6 wt % glycerol as an organic co-solvent, 0.5 wt % of CRODAFOS® N3 Acid (available from Croda Personal Care, United Kingdom), 1 wt % of LIPON IC® EG-1 as a co-solvent (available from Vantage Specialty Chemicals, Illinois), 0.22 wt % of ACTICIDE® B20 biocide (available from Thor, United Kingdom), 0.3 wt % of SURFYNOL® 440 surfactant (available from Evonik, Germany), and 3 wt % of either a yellow or black pigment dispersion.

### Example 3—Bleed Control and Optical Density

The yellow and black sample ink compositions were printed using a test inkjet printer. The test inkjet printer included an inkjet printhead that printed the yellow and black sample ink compositions onto fabric print media. Two types of fabric print media were tested: a gray knit cotton (100 wt %) fabric and a gray knit 50/50 (w/w) cotton/polyester blend. The fabric was fed through the test printer at an adjustable speed.

A test pattern was printed by the printhead while the substrate was moved beneath the printhead. The test pattern included two thin yellow lines and two thin black lines that ran along the entire length of the test pattern, and multiple alternating black and yellow boxes printed along the length of the test pattern so that the thin yellow and black lines crossed through the alternating boxes. This test pattern was designed to clearly show bleeding between the yellow and black ink colors.

The test printer included a row of LEDs having a wavelength of 395 nm. The LEDs were positioned about 30.5 cm (12 inches) away from the printhead. Ideally, in other examples the LEDs can be positioned closer to the printhead to provide faster exposure of the printed ink to the LEDs. However, in the test printer, the substrate was moved at a high speed of 50.8 cm/s (20 inches per second) from the printhead to the LEDs. Therefore, the ink was printed on the substrate and then the ink was exposed to the LEDs after about 600 ms.

Once the test pattern of printed ink reached the LED zone, then the speed of movement of the substrate was adjusted to one of three different test speeds for exposing the ink to the electromagnetic radiation from the LEDs. In one set of tests, the substrate speed remained at 50.8 cm/s (20 inches per second). In other sets of tests, the substrate was slowed to 12.7 cm/s (5 inches per second), or 2.54 cm/s (1 inch per second). Changing the speed at which the substrate moved changed the amount of time that the ink was exposed to the electromagnetic radiation from the LED. It is noted that at a speed of 20 inches per second, the ink was exposed to the LED for 50 ms, and the total energy applied from the LED per pass was 0.33 J/cm². At a speed of 5 inches per second, the ink was exposed to the LED for 200 ms, and the total energy applied per pass was 1.32 J/cm². At a speed of 1 inch per second, the ink was exposed to the LED for 1 second, and the total energy applied per pass was 6.62 J/cm². The test patterns were also printed in the same location over again with multiple printing passes to see the effect of using multiple print passes. The ink was irradiated by the LED during the individual print passes. A set of control tests were also performed in which the ink was not irradiated by the LED.

The bleed control and optical density were evaluated visually for these tests. For Bleed Control, the samples were marked Good, Poor, or Very Poor, with Good being the acceptable score for this evaluation. Optical Density was marked High, Medium, Low, or Very Low. High is the best in this comparison and Very Low was the worst. The results are shown in Table 1.

TABLE 1

| | | Speed | Bleed | |
|---|---|---|---|---|
| Passes | Substrate | (in/s) | Control | Optical Density |
| 1 | Cotton/Polyester | 1 | Good | Very Low |
| | Blend | 5 | Good | Very Low |
| | | 20 | Good | Very Low |
| | | Control | Good | Very Low |
| | Cotton | 1 | Good | Very Low |
| | | 5 | Good | Very Low |
| | | 20 | Good | Very Low |
| | | Control | Good | Very Low |
| 2 | Cotton/Polyester | 1 | — | — |
| | Blend | 5 | Good | Low |
| | | 20 | Good | Low |
| | | Control | Good | Low |
| | Cotton | 1 | — | — |
| | | 5 | Good | Low |
| | | 20 | Good | Low |
| | | Control | Good | Low |
| 3 | Cotton/Polyester | 1 | — | — |
| | Blend | 5 | Good | Medium |
| | | 20 | Poor | Medium |
| | | Control | Very Poor | Medium |
| | Cotton | 1 | — | — |
| | | 5 | Good | Medium |
| | | 20 | Poor | Medium |
| | | Control | Poor | Medium |
| 4 | Cotton/Polyester | 1 | — | — |
| | Blend | 5 | Good | High |
| | | 20 | Very Poor | High |
| | | Control | Very Poor | High |
| | Cotton | 1 | — | — |
| | | 5 | Good | High |
| | | 20 | Very Poor | High |
| | | Control | Very Poor | High |

The results show that performing multiple print passes tends to increase optical density, with the highest optical density being achieved after 4 print passes. However, performing multiple print passes also tends to degrade bleed control, e.g., more bleed is observed after printing multiple passes. It is noted that when the speed of the substrate was 1 inch per second, the fabric began to burn during the second print pass. Therefore, no additional test results were recorded for the 1 inch per second speed. The speed of 5 inches per second appears to provide the best results, with good bleed control even after 4 print passes. Using a speed of 20 inches per second did not provide a sufficient amount of electromagnetic radiation for pinning, and the results of the 20 inch per second tests were about the same as the control tests in which no LED irradiation was used at all. Accordingly, the results show that an appropriate amount of electromagnetic radiation can be selected that will provide effective pinning of the ink to control bleed. Using too fast a substrate speed, and therefore a shorter exposure time, does not provide adequate bleed control, and using too slow a substrate can result in damage to the fabric from overheating.

What is claimed is:

1. A method of printing, comprising:
jetting an ink composition onto a substrate, the ink composition comprising:
an evaporable solvent,
a colorant, and
a non-curable polymeric binder;
exposing the ink composition on the substrate to electromagnetic radiation having a wavelength from 350 nm to 420 nm, wherein exposure of the ink composition begins from 0 ms to 600 ms after jetting the ink composition, and wherein the electromagnetic radiation heats the ink composition to evaporate a portion of the evaporable solvent from the ink composition within 5 ms to 500 ms after the beginning of the exposure.

2. The method of claim 1, wherein the electromagnetic radiation is produced by a light emitting diode having a center emission wavelength of about 365 nm, about 385 nm, about 395 nm, or about 405 nm.

3. The method of claim 1, wherein the total energy applied by the electromagnetic radiation is from 0.3 J/cm² to 3 J/cm².

4. The method of claim 1, wherein the colorant is a pigment that absorbs the electromagnetic radiation to generate heat.

5. The method of claim 1, wherein the non-curable polymeric binder includes a polyurethane, a latex polymer, a hybrid latex-polyurethane co-polymer, or a combination thereof.

6. The method of claim 1, wherein the substrate is a fabric substrate that includes cotton, polyester, silk, nylon, or a blend thereof.

7. The method of claim 1, wherein no fixer composition is applied to the substrate before or after the ink composition.

8. A textile printing system, comprising:
a fabric substrate;
an inkjet printhead to jet an ink composition onto the fabric substrate;
an ink reservoir comprising the ink composition, wherein the ink reservoir is connected in fluid communication with the inkjet printhead or connectable in fluid communication with the inkjet printhead, and wherein the ink composition comprises an evaporable solvent, a colorant, and a non-curable polymeric binder; and
an electromagnetic radiation source having a center emission wavelength from 350 nm to 420 nm, the electromagnetic radiation source to expose the ink composition jetted onto the fabric substrate to electromagnetic radiation from 0 ms to 600 ms after the ink composition is jetted onto the fabric substrate to evaporate a portion of the evaporable solvent from the ink composition within 5 ms to 500 ms after beginning the exposure.

9. The system of claim 8, wherein the electromagnetic radiation source is positioned within 15 cm from a nozzle of the inkjet printhead through which the ink composition is jetted.

10. The system of claim 8, wherein the electromagnetic radiation source includes a light emitting diode having a center emission wavelength of about 365 nm, about 385 nm, about 395 nm, or about 405 nm.

11. The system of claim 8, wherein the fabric substrate includes cotton, polyester, silk, nylon, or a blend thereof.

12. An inkjet printer, comprising:
an inkjet printhead;
an ink reservoir connected in fluid communication with the inkjet printhead, wherein the ink reservoir comprises an ink composition comprising an evaporable solvent, a colorant, and a non-curable polymeric binder;
an electromagnetic radiation source having a center emission wavelength from 350 nm to 420 nm; and
a hardware controller to generate a command to:
direct the inkjet printhead to jet the ink composition onto a substrate, and
direct the electromagnetic radiation source to expose the ink composition on the substrate to electromagnetic radiation, wherein exposure of the ink composition begins from 0 ms to 600 ms after jetting the ink composition, and wherein the electromagnetic radiation heats the ink composition to evaporate a portion of the evaporable solvent from the ink composition within 5 ms to 500 ms after the beginning of the exposure.

13. The printer of claim 12, wherein the printer further comprises a carriage and wherein the electromagnetic radiation source and the inkjet printhead are positioned on the carriage.

14. The printer of claim 12, wherein the electromagnetic radiation source includes a light emitting diode having a center emission wavelength of about 365 nm, about 385 nm, about 395 nm, or about 405 nm.

15. The printer of claim 12, wherein the fabric substrate includes cotton, polyester, silk, nylon, or a blend thereof.
